(19) United States
(12) Patent Application Publication
(10) Pub. No.: US 2012/0219934 A1
(43) Pub. Date: Aug. 30, 2012

(54) System and Method for Identifying, Analyzing and Altering an Entity's Motivations and Characteristics

(76) Inventors: Brennen Ryoyo Nakane, Pasedena, CA (US); Audra Lea Nakane, Pasadena, CA (US)

(21) Appl. No.: 13/037,346

(22) Filed: Feb. 28, 2011

(51) Int. Cl. G09B 19/00

(52) U.S. Cl. 434/236

(57) ABSTRACT

A system and method for identifying and analyzing an entity's motivations and associated characteristics, by classifying and measuring the presence of sensory block indicators. The system includes the means for determining predetermined patterns of sensory block combinations; thus the presence of motivational information, including behavioral traits and other vital knowledge.

### BACKGROUND

1. Field of the Invention

The present invention relates to the field of psychological and biological testing, and more particularly, the invention relates to the interpretation of sensory motivants and motivational profiles, as well as changes in human behavior through the employment of a unique observable system and method of identification.

2.Prior Art

Most temperament and personality systems today have roots in the Four Humors Theory, first thoroughly developed during ancient times by the Greek physician Hippocrates. He believed temperaments were caused biologically by a person's dominant bodily fluid (blood, yellow bile, black bile and phlegm). Galen (AD 131-200) further advanced the temperaments but added descriptors of hot/cold and dry/wet or fire/earth and air/water, in varying degrees and balances. He saw some temperaments as being “ideally balanced” in their qualities, while others were imperfectly dominated by one quality or humor. Imbalances with excesses in one humor, and thus, imbalanced paired qualities, were named sanguine, melancholic, choleric and phlegmatic. Further, the two factor model added another one.

Later, philosophers and psychologists such as Immanuel Kant, Alfred Adler and Erich Fromm built upon these temperaments, but disregarded searching for the scientific reasons why people behaved in certain ways and instead thought of additional traits to explore. However flawed the initial concept of dominant body fluids or elements as the sole decider for a person's temperament, moving away from a biological/physiological connection to personality analysis has since greatly stunted the validity of research and understanding ever since. Biological causality still exists in psychology today, but its emphasis has shifted towards solving perceived abnormal behaviors, such as depression, ADHD, OCD, and Autism. Debates surrounding the use of drug therapy to treat possible chemical imbalances are commonplace.

Currently, temperament model and personality systems developed out of the four temperament model personality systems are primarily statistically-driven tests, which include MBTI, Disc, Big 5 Factors, etc. The DISC system, based on the work of Dr. William Moulton Marston (1893-1947) replaced the four temperaments with the qualities of Dominance, Influence, Steadiness and Conscientiousness. An individual is scored with percentages of each trait, and if trained to use the system on others, to observably guess the most likely dominant trait. The Myers Briggs Type Indicator (MBTI) was developed in 1962 when Isabel Myers Briggs and Katherine Briggs built upon Carl Gustav Jung's (1875-1961) interpretation of the four temperaments, termed “psychological types”: the introverted and extroverted versions of thinking, feeling, sensation and intuition, as well as the added factors of judging and perceiving. These were combined to form 16 types using the terms I/E, N/S, F/T and J/P. David Kiersey's book ‘Please Understand Me (I and II)’ borrowed the terms used by the MBTI and also reverted back to a basic four temperament explanation of the types, putting the qualities of NF, NT, SJ and SP into groups; Idealist, Rational, Guardian and Artisan.

The Big Five Factors initial model was advanced by Ernest Tupes and Raymond Cristal in 1961, and gained an academic audience in the 1990s after being adapted and promoted by researchers, including Lewis Goldberg. It has been widely used within the psychology and psychotherapy community since that time, and is the most commonly accepted personality model within contemporary academic circles. The traits used in the model consist of Openness, Conscientiousness, Extraversion, Agreeableness and Neuroticism. When scored, the subject is given a percentile rating which indicates the amount present for that trait; low percentages represent strong behaviors opposite or “reverse” that of the trait. The Big Five Factor model has been criticized by many researchers, including Jack Block (Psychological Bulletin, Vol 117(2), March 1995) as a faulty “data-driven investigation”; not providing an organic understanding of personality nor a solution for overcoming challenges. Color code, Enneagram, astrology, etc.

If we examine Hippocrates, and later, Galen's work, we see that their concepts of earth/water/fire/air, hot/cold/wet/dry, sanguine/choleric/phlegmatic/melancholic are all deeply rooted in an ancient, superstitious understanding of the causality of life. Because these were the building blocks for all future systems, they all share this fundamental flaw. Most are based upon stereotypes, archetypes, or mythological figures.

Efforts also shifted towards sociological studies and data gathering or an anthropological view, rather than looking at the underlying biological mechanisms. This type of debate can be seen with Darwin's view on the universality of emotions versus Margaret Mead's anthropological view that traits were based on the effects of socialization. Ultimately, Paul Ekman helped to prove for once and for all the universality of our biological design. The truths behind universality can be understood in the same way we know that humans require air, water, food, and shelter to survive; this is not up for debate or analysis but rather the intricacies of these components is what we explore in more depth. Ekman's work on microexpressions furthered the concept that expressions were universally tied to emotions, regardless of culture or socialization.

In sharp contrast to existing personality analysis, our system uses fundamental scientific principles in order to show motivations rather than traits, since traits are properties that can change at any given time. For instance, a piece of wood could have the trait of being brown, yet when it mixes with fire, the property of brown turns to black. So too, our system does not take a person out of the context upon which they are being analyzed for that trait, nor does it inject the actor-observer bias from the scientist himself.

In psychology, trait theory is the predominant model in the discussion of the study of human personality. Trait theorists are primarily interested in the measurement of traits, which can be defined as habitual patterns of behavior, thought, and emotion (Psychology-Kassin 2003). From this viewpoint, traits are relatively stable over time, differ among individuals, and influence behavior.

Subsets of traits are usually associated to the parent factor or temperament. Oftentimes, however, there is little agreement as to what sub-traits should be included. Also, conflicting sub-traits can convolute each factor, making it confusing to define exactly what the parent trait's true properties are.

No person is just a series of traits, like being introverted or extroverted, but that they change in context to the situation. Percentages of fixed inorganic, stagnant, individual traits pigeon-hole organic people into boxes which contain judgment and bias. Examples of this include words like ‘Unscrupulous’, ‘Introverted’, etc.

Some questionnaire-based psychological profiling tests, oftentimes used during the hiring process to identify ideal candidates for a particular job, look to further offset the challenges presented by trait theory by creating questions that place an individual within the context of a situation to elicit what traits might then emerge. Although potentially more effective for hiring amiable customer service reps or rigid gatekeeper assistants, these models tend to break down when a larger range of environments must be considered, such as whether that amiable customer service rep is always cheery both at work and home and under all circumstances. The hiring company may not care about these other fragments of personality that do not show during work hours but the customer service reps themselves, looking for fulfillment and happiness in their personal lives as well, certainly do. And, even within the context of corporate structure, the more advanced-level the job position, the more subjective the assessment becomes as to what the ideal CEO or Senior VP maybe, especially in light of the current company's culture and future goals.

Measuring a trait into a single number, such as a scale of Extroverted or Agreeableness, averages out critical data points along the continuum thereby losing valuable results. This also ignores the context of the interaction and introduces a heightened actor-observer bias with those deciding and recording the degree of the trait present. For example, a person may be introverted or not agreeable in public except when around people that are supportive, and extroverted or agreeable at home except when harshly punished. The exact opposite, we have found, may be the case with another individual, thereby reducing, but not eliminating, the amount we can attribute the change in behavior solely with a universal response to external stimuli or environment such as punishment. And the researchers' own dispositional biases or motivant-based profile may also color their measurement of the Big Five factors.

For all the various different systems that have come about to understand personality, most of them have been focused on capturing the symptoms rather than figuring out the root cause. This is similar to looking at the results of the fractal and tracking all of this endless amounts of data without then taking this data to seek with the root cause is. In other systems that claim various different traits, those traits inherently have a bias to them based off the perspective of the person. This bias even extends to the person being interviewed themselves. Although some systems claim that they account for these things, a third level complexity is necessary; the interviewer with a bias then interviews a person with a bias while attempting to trick that person into answering without bias to a third structural systematic bias to the assessment!

Neurolinguistic programming (NLP) is a conglomeration of disciplines first developed by Richard Bandler and John Grinder in the mid-70s. It used such disciplines such as Cognitive Behavioral Therapy and hypnotic language patterns to achieve quick results in therapy. Because many practitioners are not licensed therapists with a psychiatry or psychology degree; along with excessive claims and a more of a mystical aspect, it been largely shunned by the academic community. One finding, however, has gained widespread acceptance, that of eye accessing cues, which states that the direction of one's eyes determines what part of the brain a person is using at any particular time. Although there is a small percentage of variation, the vast majority of people, regardless of culture, exhibit these tendencies. The FBI, CIA, military, and other law enforcement have used this information particularly as it relates to the “remembering” or “constructing” of various different events. They found that if a person looks to the left they are remembering, where as if one looks to the right, they are creating; both in either visual, auditory, feeling or thinking places. Many felt that later assertions went too far by stating that matching someone's words (such as visually-based words or auditorily based words) or mirroring their body posture would create a deepened sense of rapport. Although the academic community has shunned these findings, sales seminars across United States have championed this thought and “mirroring and matching” techniques are taught widespread across the sales community. The promise of NLP was overshadowed by making too many unwarranted assertions too quickly, which caused the academic community to turn from many of its findings. This included eye accessing cues; the academic community primarily focused on studies towards disproving its validity rather than proving. Nevertheless, top government officials have used this understanding and incorporated with other biometric feedback systems to determine whether or not someone is lying.

NLP also uses many of the classic conditioning principles to associate a particular feeling or emotional state with a trigger, such as an auditory or visual command, in order to induce positive states and remove negative states. In regards to these sensory representations, NLP looks to find the pattern of whether or not a sense was internally or externally created or was created or remembered; thus, asks a series of questions to try to discover the negative pattern. They believe that by finding this pattern, one can learn what a person's strategies are to achieving any goal or outcome, whether positive or negative. Hypnotic language patterns look to solve for this by inducing a state of openness to various commands and confusing the “critic mind” whereas the “specificity model” looks to question and subvert limiting beliefs. The challenge with NLP rests in its emphasis on visual, auditory and kinesthetic remaining as separate aspects, thus creating primarily three categories which vastly oversimply human behavior. In addition, by requiring the series of questions to elicit someone's strategy in the various areas, it becomes overly complex and puts too much faith in a pattern being consistent regardless of external factors.

Most prior patents have based their methods of profiling upon the prior systems already mentioned. Some look to solve the problems associated with these systems by creating better-organized computer programs, questionnaires, or graphs; the challenges inherent in the systems being utilized, however, remain.

Just as human life depends upon care, water, food, and shelter and these things are consistent across the board, so to is our dependence on the senses to understand the world around us. Our system differs in that, although it has combinations which are foolproof for the sense of motivation, it simply gathers which senses are being combined at any one moment, and which parts of the brain are being utilized. Although human behavior is very complex, ultimately it is based upon finite sets of information which have been have labeled “the senses”. Our system takes these senses, and the behaviors and reactions associated with them, into account.

### SUMMARY OF THE INVENTION

A system for understanding human motivation and behavior and its interpretation are explained and provided. Understanding these motivations and behaviors supplies a means to effectively interpret interactions, choices, preferences and values. This information can then be used to, for example, address and work through personal challenges, communicate with others more effectively, and understand the goals and tendencies of individuals, cultures and ideologies.

### BRIEF DESCRIPTION OF DRAWINGS

The invention, together with further advantages thereof, may best be understood by reference of the following description of embodiments taken in conjunction with the accompanying drawings in which:

FIG. 1 is a Motivant Pathway Cycle for project accomplishment.

FIG. 2 is a Head Lean Chart corresponding motivants to directional leans (from the view of the observer, meaning left-side of paper represents right-side of person being observed).

FIG. 3 is a Motivant Sequence illustrating motivant and corresponding sensory blocks (first two) followed by flipside sensory blocks (last two) and the resulting motivant.

FIG. 4 is an Entity Profile example showing how primary and secondary motivants combined and cancel out to determine transports along with flipside, stuck, goal, and flipside goal motivants.

FIG. 5 is an Overlay example of how an entity's temporary mode is altered by the increase/decrease of internal/external stimuli.

FIG. 6 is a set of common Compatibility Couplings of motivants in personal and professional relationships.

FIG. 7 is an Internal/External Equilibrium Model showing how combined sensory blocks create both an external motivant as well as separated internal sensory blocks and lead to a balance of all four sensory blocks.

FIG. 8.1 is a list of Sensory Block Combinations and the resulting motivant.

FIG. 8.2 is a list of Sensory Blocks and examples of corresponding characteristics.

FIG. 9.1 is a list of Motivants and examples of corresponding eye-accessing cue pattern combinations.

FIG. 9.2 is a list of Motivants and examples of corresponding word cue pattern combinations.

FIG. 9.3 is a list of Motivants and examples of corresponding head lean patterns.

FIG. 9.4 is a list of Motivants and examples of corresponding gestures.

FIG. 10 is a Facial Sensory Block Map which correlates motivants and senses to facial movements beyond traditional emotional identification.

### DETAILED DESCRIPTION OF INVENTION

### Profiling:

Much work has been done in the area of analyzing both individuals as well as group entities such as companies, countries and so forth. This has usually fallen within the studies and categories of psychology and sociology. This has led to number of theories, and oftentimes these theories of analysis produced a number of traits, yet oftentimes these traits lack proper causality. Certain systems such as NLP, Myers-Briggs and the Big Five Factors have turned analysis into a science, but these still rely primarily upon noticing the symptoms such as moods or traits without explaining underlying causes. We have studied these systems extensively and developed a non-obvious, innovative process to not only more accurately predict these traits, behaviors etc. but also explain why these are so. Further, we have identified the complexity of human behavior by addressing the variable patterns that exist as a correlation between set amounts of inputs and outputs; the 5 senses plus thinking. Thus, there are limited amounts of inputs and outputs, but with an infinite amount of variation and combination. This, along with the variability of choice and stimulus response, produces a predictive algorithm for all human entities that rely upon these sensory inputs and outputs. Combining these understandings with further empirical research, we have uncovered observable patterns which not only represent current emotional states, but also predict future actions and changes. These are based off of uncovering motivations that are well known as is the case with, for example, a well known electrical circuit, but not understood in this patentable combination and the insights we reveal through our system. There also exists a symbiotic relationship, meaning that the outputs can be consciously altered to change (including, but not limited to) internal states or group behaviors. Even further, our physiological discoveries such as head leans and micro-motivants line up with these sensory combinations, so that individuals or computer systems can profile an individual fairly easily for both short and long term understandings about that individual.

### Senses: The Building Blocks

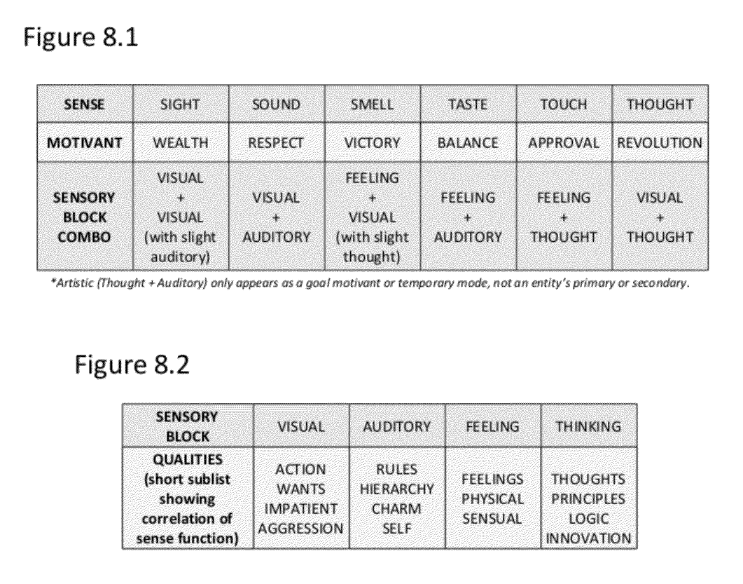

### (See FIG. 8.2)

The sensory blocks within an individual of visual, auditory, feeling and thinking each have their own qualities which influence a person; their behavior changes depending on the state they are in, and which mode they are using at the time. For example, someone who is accessing the visual part of their brain and physiology will have different behavioral traits which correspond with that mode; if strongly visual, the behavioral traits which accompany it are (including, but not limited to) wants, impatience and aggression. An auditory state triggers (including, but not limited to) rules, charm, self focus and so on with the feeling and thinking states.

The motivants, as we named them, the building blocks for the profiles within our system, are created when the motivations which naturally occur when two sensory blocks are combined in patterns, of which every individual has a distinct make up, are formed.

### (See FIG. 8.1)

The motivants consist of the following: Wealth, Respect, Victory, Balance, Revolution and Approval.

All motivants are formed with the combination of two sensory blocks. Although these two senses combine to form a motivant, motivants can switch back and forth from each other. The motivant that is predominant in any entity, based off of factors like biological disposition or historical shared experiences, is called a primary motivant. The secondary motivant is one that occurs consistently, but tends not to be initially obvious, as is the primary. The flip side motivant is the corresponding two senses combined that comprise the internal part of the internal/external equilibrium when they are combined and released. The secondary motivant's flip side is termed the stuck motivant because, although it does occasionally shift, it gets stuck on a much more frequent basis and thus represents one part of the entity's personality or characteristics that it would need to work on.

Just like two senses combine to form a motivant, two motivants combine to form goal motivants. The combining motivants can be thought of as the means, and the resulting goal motivant can be thought of as the ends. There are a total of four goal motivants that tend to occur and thus define that entity's profile. For example, a primary Revolution and secondary Victory could be an entity's profile. It determines a person's flip-side, stuck, and goal motivants; in this case, for example, a Revolution Victory profile has a goal of Approval, a flip side of Balance Victory with a goal of Respect, and a stuck motivant of Wealth.

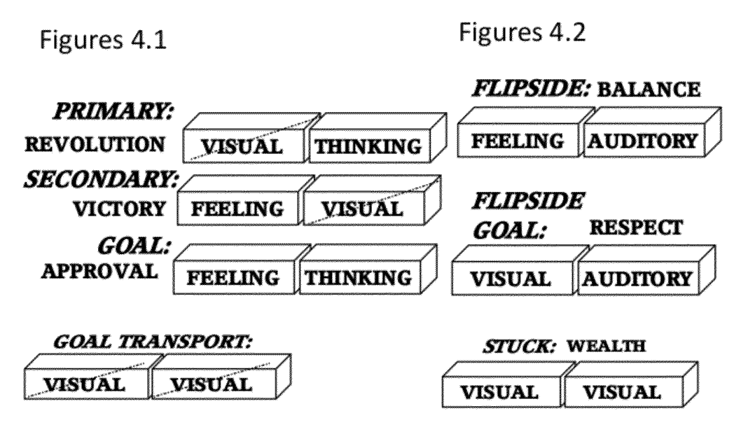

### (See FIG. 4)

A person can be in any motivant at any time, especially since they can control their motivants through adjustments of the sensory inputs and outputs. When someone does this, there will be a primary and secondary present but we would not call these profile motivants because they are not fixed within that entity's profile. Rather, we would say that they are in a particular mode, with the same terms as the six motivants. This mode represents a temporary, moment-to-moment, state of being. This is where much is revealed with head leans and micro-motivants, giving real-time, second-by-second biometric physiological feedback for analysis in addition to the underlying, more constant motivant profile. These primary and secondary modes would have goal modes that may not fall into the four main profile goal modes but rather create infinite possibilities.

Visual is impatient because a picture is the fastest sensory medium. It is associated with action and wants. Therefore, a Wealth motivant tends to be the most impatient and action-oriented because it is formed with a double visual sense combination and motivated by visually appealing things, such as gold. It also can be focused on double control as well, and preferential treatment. Auditory tends to be rule and hierarchy-driven with a focus on self-expression, similar to language. Therefore, the Respect motivant combines the senses of visual and auditory to want certain things, but use rules and hierarchy in order to get them. Feeling is more of a feeling, touching, physically and emotionally expressive sense. Thus, when it is combined with Visual it forms a Victory motivant by seeing a goal and then using body and brute force to accomplish that objective. When Feeling is combined with Auditory, it becomes a Balance motivant which replaces the need to achieve a goal with rules of comfort or charming social interactions. Thus, areas of comfort, ease, security, travel, tradition and conversations at a dinner party become paramount. Thinking is defined by principles, or goals within the mind, innovation, and theories. Thus, combining Thinking with Visual creates a Revolution motivant, guided by principles of change, ideal, and innovation. When Thinking is combined with Feeling, it produces an Approval motivant, which looks to consider the meaning behind the interactions, people and situations around them, by thinking and feeling about others' state of mind and emotions.

Although we've used the combination of visual, auditory, thinking, and feeling twice to form the six motivants, we've found that they, in more simplistic mapping, correlate to the five senses plus thinking. (See FIG. 8.1) Sight is wealth (double visual), Sound is respect (strong auditory), Smell is victory (touching closest to eyes in nostrils), Taste is balance (touch closest to the feeling zone of the mouth), Touch is approval (touching over the entire body and internally touching thoughts), and Thought is revolution (thoughts that stay confined in the mind and head region closest to visual).

How the four goal motivants are formed also make sense. The pattern is that the two motivant components are added up and the repeating sense becomes the transport, which is defined as the vehicle the goal prefers for its objective to be reached. The other two senses combine to form the goal motivant, which represents what they want to see accomplished. Thus, a revolution-victory person will use innovation (revolution) and brute force (victory) to try and accomplish a bottomline (visual transport) approval (considerate idealism) or can give a bottomline disapproval as well. (see FIG. 4)

When the flip-sides and stuck motivants appear, these goals change depending upon which senses double into a transport and which forms the actual goal. The only caveat is if there is no doubled sense, it is usually because there is an artistic (auditory and auditory digital/thinking) goal or a black & white (victory) transport. The figures illustrate these combinations. (see FIG. 4)

### Influencing Current State by Adding or Subtracting Key Sensory Elements:

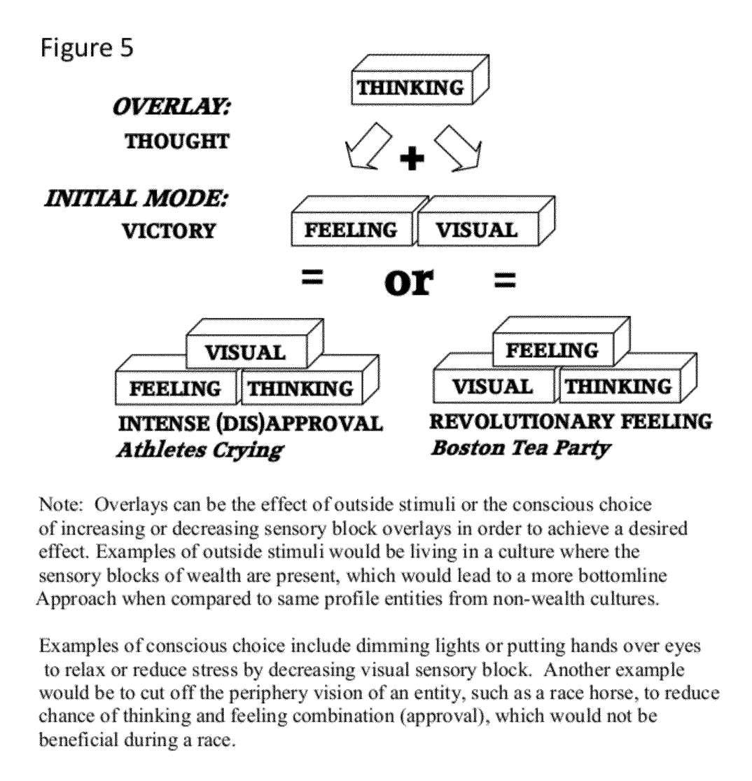

### (See FIG. 5)

These moment-to-moment shifts can be consciously influenced by an individual towards themselves, others, or a group of people. An example of this would be taking an individual who is very impatient, which is characteristic of a high visual component, and dimming the lights in order to reduce all external visual sensory input. An example of this would be fine dining restaurants and nightclubs looking to relax their customers.

### Moment by Moment Shifts:

### (See FIG. 5)

While overall entity profiles are predominantly formed by factors such as biological, chemical, neurological, and other physiological compositions for an individual, and by geographical, ethnic/racial genetic tendencies, social and cultural norms, and historical context, this base overall structure dynamically interacts with various factors on a moment-to-moment basis. What differentiates our system from many others is to also be able to account for these moment-to-moment shifts. For example, a person who has a primary Victory motivant is largely influenced by the Feeling and Visual components. However, in any given moment, this person can be presented with a thought, event, principle, or goal that generates internally a high level of thinking. When thinking is combined with feeling, it generates an Approval motivant, characterized by an emotional sensitivity. This, combined with the already present visual characteristics can bring this person to uncharacteristically strong displays of affection, crying, or dejection. The best example of this can be seen at championship sporting events, where Victory is a strong motivation and where the champions cry tears of joy while hugging each other, and those defeated cry tears of pain while consoling each other.

### Overlays:

Since an individual entity can be thought of as an object that exists as a member of a larger object and possessing more finite distinguishing properties, our system helps to account for how an individual entity, such as a person's individual personality profile, consists of overlays, which are additional entity, situational, and dynamic sensory profiles. Simply stated, a person is also a member of the family which is a member of the community which is a member of the geographic region which is a member of a country. They're also oftentimes members of the work environment, religious affiliation, interests and hobbies, etc. They have a birth order, unique personal history, and family dynamics. All these comprise overlays. As the person enters into new environments, such as shopping malls, they're then interacting with additional overlays such as the mood, lighting, and music of that shopping mall and the individual stores within that mall, not to mention the various individuals and groups of people at that shopping mall.

Building upon the last example, we have found that people in social situations tend to go to an overlay that is primarily formed with Visual and Auditory components. The visual characterizes a want or desire and the auditory characterizes hierarchy and rules. This is explained under the overall umbrella of the Respect motivant. Therefore, when an individual goes into a social situation, there will be a tendency for them to be influenced more so by the motivation to gain and give respect, and they will tend to be more verbal in nature. Even a shy person will still muster up the courage to place an order at a fast food restaurant. Thus in the situation where a restaurant dims its lights and adds soothing music, it decreases the Visual components naturally occurring in all people in social situations, and increases the already present Auditory component while injecting a Feeling component. This combination between Auditory and Feeling forms the motivant Balance; characterized by the tendency to enjoy epicurean and sensual experience. Thus, the restaurant has increased its chances to sell their finest wines and desserts.

### Internal-External Equilibrium:

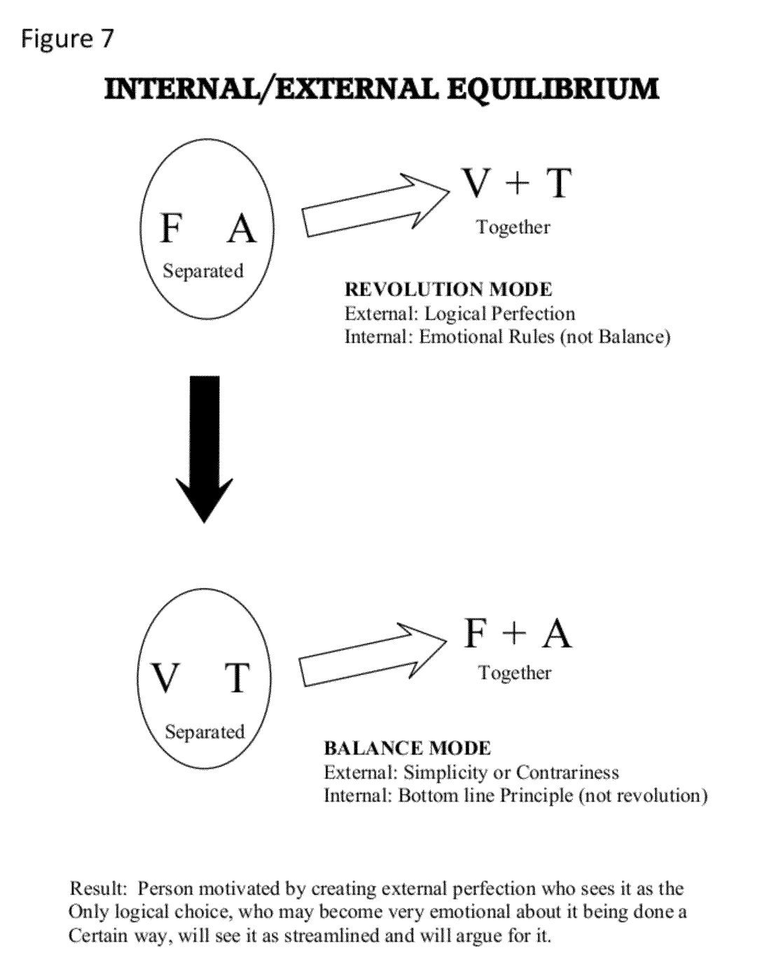

### (See FIG. 7)

Every motivant is created with the sensory blocks of V, A, F, T. These are viewed as external representations of an individual's nature. There is, however, an internal-external equilibrium, or structure, that 1) defines how someone internally processes information to then externally decode and relay that information outward; and 2) takes external information gathered, inward, and creates an internal structure and understanding from the information received. For example, someone with a primary Approval motivant, who has an external process of Feeling and Thinking, has an internal process of visualized pictures (wants) and rules which are the genesis point from which their feelings and thoughts are created. Conversely, external feelings and thoughts can be the genesis from which internal pictures and rules are then created.

Within this internal structure, the components that make up the internal process remain separate, thus having properties which are different than the combined components' motivant as a whole. For example, returning to the primary Approval motivant, it contains the internal structure of Visual and Auditory, which as external components comprise the motivant of Respect. As an internal structure, however, they are simply two separate sensory blocks, Visual and Auditory, with traits and aspects of their own, not a Respect process as understood externally. These internal-external equilibrium structures define and explain the flip-side of motivants; when situations push what is normally an internal process to the external, a hyper-version of that primary's flip-side motivant emerges. We also explain and define some of the seemingly opposite tendencies displayed by a motivant as the ‘fulcrum point’ of that motivant, in which you can see certain flip-side traits leak through unexpectedly; for example, a Respect person who desires the spotlight, fame; wants admiration from many people, yet, at the same time, wants extreme privacy in their personal life.

### Cyclical Tendencies:

### (FIG. 4)

The nature of an individual's personality is complex, and yet there is an identifiable, cyclical nature which can be explained through the flip-side of a person's primary motivant, their secondary motivant, and the goal that is created by the primary and secondary motivants combined, as well as the flip-side and the secondary combined. For example, a primary Revolution motivant with a secondary Victory will have a goal of Approval. However, as explained shortly, in some circumstances the flip-side of the motivant (as in this example, the flip-side of Revolution, Balance) also combines with a person's secondary to create a different goal. When shifts occur with the primary motivant, other motivations are also affected. Thus, a person with this Revolution-Victory-Approval goal make-up at times becomes a Balance-Victory-Respect goal. These changes are apparent in an individual and explain goal and behavioral shifts that are constant and cyclical.

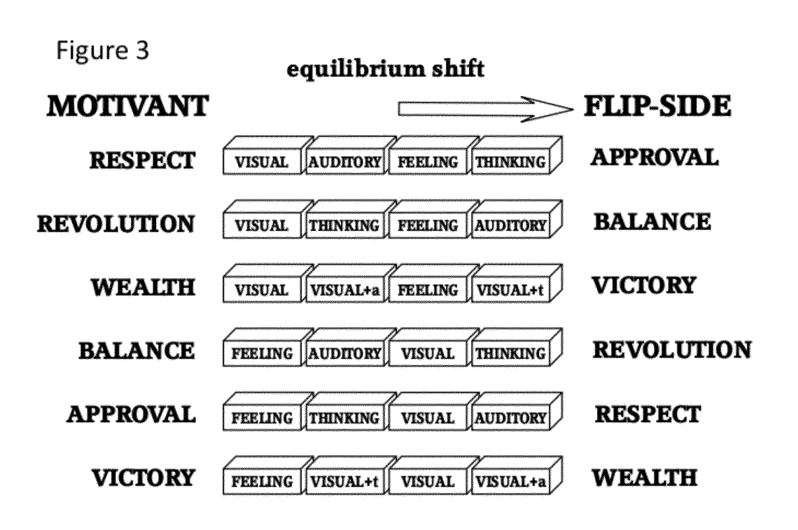

### (See FIG. 3)

Each primary motivant has what we term a flip-side; a motivant that the primary will flip over to in various situations which upset, for good or bad, the primary motivant's structure or comfortable tendency of being. These flip-sides are composed of the same components that make-up each motivant's internal system, as explained in ‘Internal-External Equilibrium’. In these situations, the primary motivant's internal structure then becomes external, creating a very strong or hyper-version of the flip side. For example, someone with a primary Approval motivant, having a tendency toward shy behavior, problems speaking up and defending oneself, being in the spotlight etc. will flip to his/her flip-side, Respect, in varying circumstances which upset the feeling of approval, either in extreme situations of strong approval, or conversely, strong disapproval. In this way, many primary Approval people can thrive onstage in front of the “love from the audience” where they can feel comfortable expressing their emotional nature in an artistic (athletic, etc.) way as well as a very strong connection to the audience. Approval flips to a hyper-Respect place, where they adore the spotlight, exude confidence, follow rules and steps to success, while still retaining Approval's strong emotion to which others can relate, as well as the Approval tendency for perfection. It is for this reason that you can find many shy and otherwise withdrawn individuals who excel as professional singers and actors, athletes, Olympic gold medalists, etc. Alternately, in situations where a person with a primary Approval motivant feels great disapproval, either externally from others or as an internal emotion, they will go to a hyper-Respect in which they feel comfortable being extremely vocal about their anger and/or frustration. This is illustrated with the example of someone who tends to remain quiet, allowing the actions of others which have hurt them to be ignored and stuffed internally, only for that person to seemingly explode with anger at some point, bringing up all past resentments in a “volcano” of emotion which catches the receiver of this explosion off guard.

### Eyes Patterns:

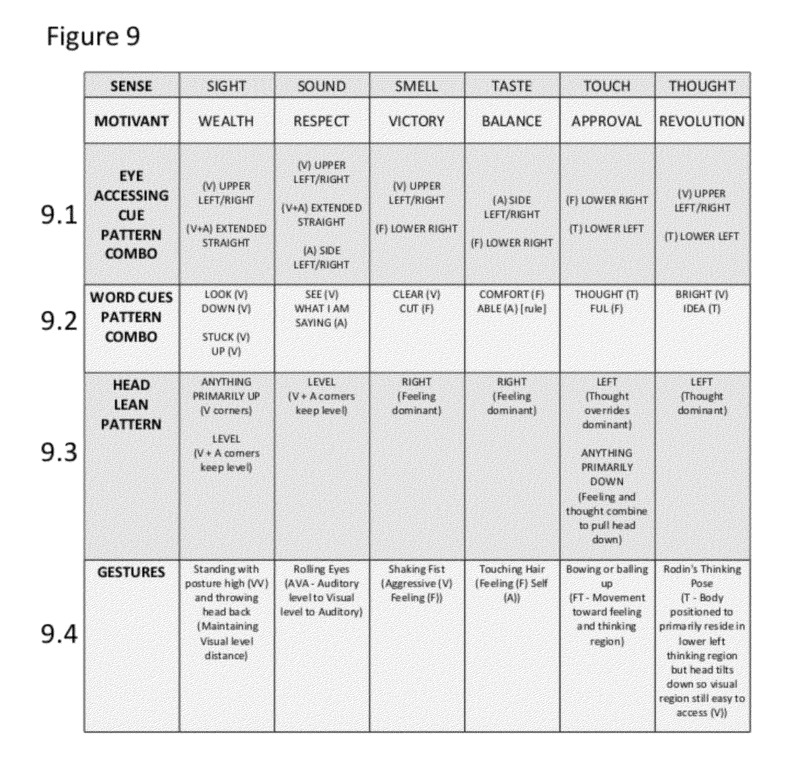

### (see FIG. 9.1)

Eye movements reflect the sensory blocks of visual, auditory, feeling and thinking, creating an easily visible way to cue off of these movements and distinguish whether someone is in a visual, auditory, feeling or thinking state. NLP created this concept in their work, but were very limited in their understanding and application of the information received through these eye accessing cues; each were given simple traits which were overly generic, without complexity, pattern, predictive ability or accuracy. We uncovered the recurrent patterns of these eye movements which reflect the representational systems that create the distinct personality traits, or motivants, modes and goals, as mentioned. Because the combination of two representational systems, V, A, F, and T (the two which combine to form our unique motivants) can be seen in the eye movement patterns of an individual, it provides an easily identifiable method of recognizing someone's primary and secondary motivant, current motivant and/or any shifts which occur from moment to moment. For example, an eye pattern in which the eyes move straight across the middle of the eye to the right or left and then down to right, which remains as a fairly consistent pattern, would identify a person who has either a primary Balance motivant, or someone who is in a strong Balance mode at the time. This is evident because the Balance motivant, consisting of Feeling and Auditory components, is being revealed through the eye pattern of the individual, along with balancing verbal statements and/or body and head posturing which coincide with that mode's distinguishing characteristics. A short balancing or contrarian statement or thought is also apparent in the head movement and eye movement of the individual, and shows a quick shift into Balance mode in what may be otherwise a non-balance conversation or state. It is very apparent when someone moves in and out of these different modes because the eyes follow suit.

### Head and Body Leans:

### (See FIG. 2, FIG. 9.3)

Along with eye patterns, the head and/or body will lean certain directions which correspond directly with, and reflect, the motivational state that an individual is in. This is another identification method in our system which is easily visible in many situations, including, but not limited to, still photographs and group environments. These visible leans and patterns include, but are not limited to, the following observational traits:

The Wealth motivant, highly visual, visible as head held very high, slightly thrown back, chin thrust forward. Body; with chest thrust forward.

Victory and Balance, both with Feeling components, reveal their head and body leans to (the individual's) right side; Feeling is recognized to occur on the right, as with the eye accessing cues discussed earlier.

Respect: head and body remain the most level, straight forward and up-and-down, authoritative or confidently.

Revolution and Approval, both with Thinking components, lean to the left, as in the thinking direction of the eye accessing cues, with a slight exception for Approval. Because Approval is composed of a strong Feeling component and strong Thinking component, there will be more of a tendency for someone in Approval mode to have a slight right lean at times, going back and forth between the right and left leans, especially with eyes gazing down to the right or left while leaning.

Once a primary mode is established, and the strong leans and eye movements are visible, it becomes evidently clear when someone shifts their body or eyes that a change of some kind has taken place. Thus, even small movements indicate how they are reacting to environmental, conversational, and emotional changes, and allow the observer to respond to those shifts. Similar to head and body leans, there are patterns and tendencies toward certain physical gestures, depending on the motivant. (see FIG. 9.4) For example, someone in a Victory mode will tend to do an arm and fist pump either with their right or left arm, but while leaning to the right side, where a Victory feeling resides. This gesture usually occurs alongside the verbal cue “Yes!”

### Verbal Cues:

### (See FIG. 9.2)

Because the sensory blocks of V, A, F, T represent states that can be reflected in conversation, either written or spoken, yet another step in our profiling system is provided. In this way, one is able to identify the motivational state by breaking apart the words used and recognizing the pattern which exists as shown in the motivants. For example, someone in Respect mode will speak in the terms of Respect, using words that are both visual and auditory in nature: a phrase such as “See what I'm saying?” has the components of Visual (see) and Auditory (saying); that sentence also coincides with the overall behavioral traits and speech tendencies of a Respect type. This tendency towards certain words and phrases is a very strong aspect of the profile, and each motivant has its own list of verbal cues which can be used to aurally identify and further aid in the profiling process, along with the ability to build rapport and/or affect changes in another entity through conversation.

### Micro-Motivants:

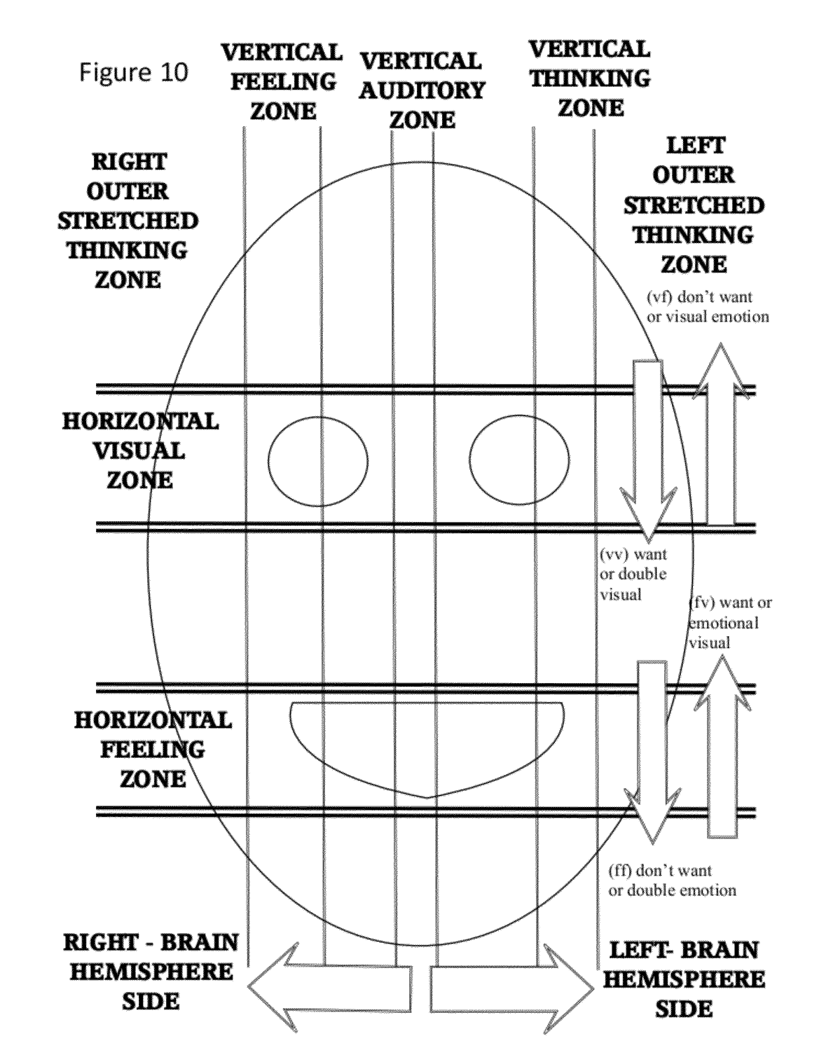

### (See FIG. 10)

Micro-expressions are patterns of facial movements that were found to illustrate various different expressions of emotion. The strengths of micro-expressions came to be evident of universality when it was scientifically discovered that all human behavior had underlying connective structures. We believe these underlying structures can best be thought of as the sensory inputs and outputs, and therefore, can help better explain what is seen in facial expressions. Thus, expressions are not simply isolated reactions or emotions without pattern; rather they are connected to sensory blocks, motivants and modes and reveal the internal and external processes an individual is cycling through. These expressions which are tied to the senses and motivations are termed Micro-motivants; further cues that give innumerable insight into the underlying motivations at any moment, as well as patterns and profiles.

Horizontal zones: the top zones of the eyebrows represent the visual zone; this makes sense, purely from the location of the face, because the eyes and eyebrows control vision.

The lower vision section is the emotional section; this also makes sense given the fact that the majority of all feeling occurs through the body, which is below the head. Also, with the lips and the tongue, which are the feeling components of the face; it is their job to touch/interact with food.

Vertical zones: start in the inner section of the face, the auditory section; this makes sense because the mouth is in the middle of the face.

The outer sections of the face are the thought zones. By utilizing this zone information, one can read and interpret various minute micro-expressions, determining which sensory inputs and outputs are occurring.

### Strengths and Weaknesses:

Each individual motivant has strengths and weaknesses which are unique to that type, and in addition, each profile, created by the primary, secondary, flip-side, goal and stuck motivants, has unique strengths and weaknesses associated to it. Thus, a very thorough understanding of someone's personality, challenges, possible blind-spots, and strongest assets is easily attained after the full profile has been recognized and/or accepted. This becomes an important aid to success, as one can focus on eliminating and downplaying weaknesses perhaps not otherwise aware of, while choosing to strengthen positive aspects, of which they were perhaps not formerly fully aware either.

### Behavioral, Physiological, Appearance, and Trait Tendencies:

We have uncovered patterns among individuals with similar motivants and/or profiles which show strong similarities beyond sensory blocks. These tendencies include, but are not limited to: likes, dislikes and preferences; similarity in physical mannerisms and vocal quality; similar physical traits such as facial structure and facial features, body type and builds; decision-making tendencies and reactions to stimulus; habits, hobbies and careers and so forth. After learning and recognizing these tendencies and patterns, it becomes even easier to quickly profile the probable aspects of personality that may be present in an individual. This is, of course, never meant to be used in a negative way in order to stereotype prejudicially, but rather with the hope that we can see the connectivity which unites us by showing similarity within motivants/profiles which exist among individuals of all groups, genders, races, etc.

### Positive and Negative Choice:

Every motivant mode has tendencies both positively and negatively which an individual, group etc. can choose to embrace. There is no “good” or “bad” type, because the element of choice always resides in each type. For an example, a Wealth motivant at its best is tireless in the pursuit and achievement of providing, usually, but not always, through financial or physical means: companies, organizations and charities. It is a very bottomline, action-oriented motivant which quickly and comfortably makes decisions, leads and dictates others, and with positive choice, accomplishes positive outcomes and affects situations that can benefit many. With negative choice, a Wealth motivant's characteristics of quick decision-making can become extreme impatience, action can become a tendency toward violent behavior, leadership can become dictatorship and cruelty. The collection of wealth that could be shared with many and the sponsorship of charity becomes a legacy of selfishness and perverse desire for strange exclusivities. Every profile's make-up has the opportunity to uniquely affect their environment in very positive ways; every entity containing much needed traits the other profiles lack. Thus, everyone, every group, every country etc. is dependent upon the others' positive profile strengths and abilities and the positive choices made.

### Compatibility:

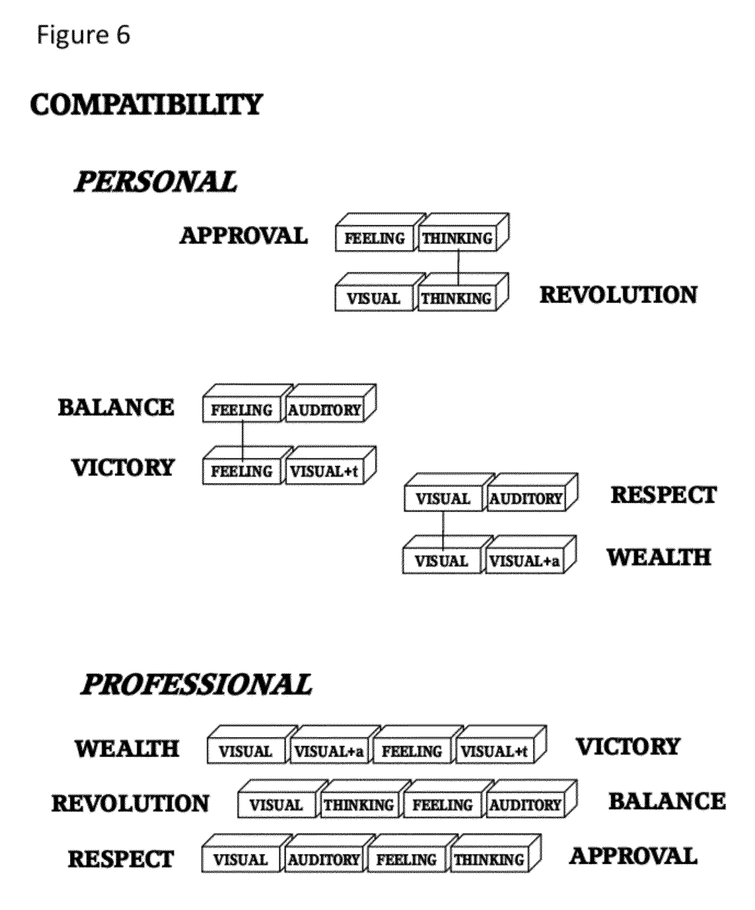

### (See FIG. 6)

The distinct qualities and traits of the primary motivants create strong compatibility tendencies among the motivants. There exist compatibility patterns (including, but not limited to, the examples in FIG. 6) which differ depending on environment, that indicate a magnetic effect of motivants toward one another. These instances include 1) personal relationship compatibility tendencies (which tend to differ depending on whether it is a love relationship versus friendship versus familial); and 2) professional relationship compatibility tendencies. This exists because a primary motivant desires, and is drawn to, specific traits belonging to another's motivant which change depending on the nature of, and goals for, the relationship. Where, for example, someone with a primary Revolution motivant may tend to gravitate toward someone with an Approval motivant in a love relationship, they may not tend to gravitate toward someone with that type of motivant in a professional environment. In this case, it may be more likely that they would work well with a primary Balance motivant.

In the personal love relationship example, the two motivants Approval and Revolution share similar traits including, but not limited to: thought, sexuality, perfectionism, principle and introspection while also having polar traits of emotion and logic, allowing for a magnetic polar connection which completes the other motivant's need for aspects they are missing, yet still containing understanding/ability to relate. In a professional relationship, however, this same pairing could create a dynamic which does not help move projects into action, due to a thought based, over-perfectionistic paralysis. In addition, the considerate, emotional analysis of an Approval motivant can upset the defiantly innovative, logical action of a Revolution motivant, especially when decision-making is involved. For this reason, Balance may be a better professional pairing; it would share Revolution's tendencies enough (when it goes to its flip-side) to understand the logical thought process, but be able to balance Revolution's desire to go to extremes that may harm the overall business. A Balance motivant may accomplish this without getting overly emotional as an Approval motivant would tend to do in the same situation.

### Possible Embodiments for System Include, but are Not Limited to, the Following Areas:

Business—motivation, sales, marketing, teambuilding, negotiations, leadership, production, R&D, communication analysis, management, hiring, strategy, cross-cultural, predicting patterns, inventory anticipation

Politics—campaigns, speech writing, party subculture, image projection, lobbying, political discourse

Military and law enforcement—criminal profiling, lie detection, interrogation, behavioral, training techniques

Sports—peak performance, strategy, teambuilding, recruitment, training methods

Academia and history—analysis of biographies, historical figures, educational teaching and learning styles, disciplinary approaches

Schools of thought—analysis of theories, philosophies, religions

Science—scientific research, diagnosis of diseases, health education programs correlated to motivate patients, doctors interacting with patients

Therapy—client profile, optimize approach relative to profile, therapist, self-help

Family—dynamics, parenting, understanding and resolving challenges, childhood issues, instant communication

Relationships—compatibility, courtship, communication, understanding

Current events—commentary on news, political coverage

Faith—compassion for others, pensions of shortcomings, understanding of God's image

Arts and popular culture—understanding celebrities, artists, merits/progression of art

### Example of System Embodiment Use:

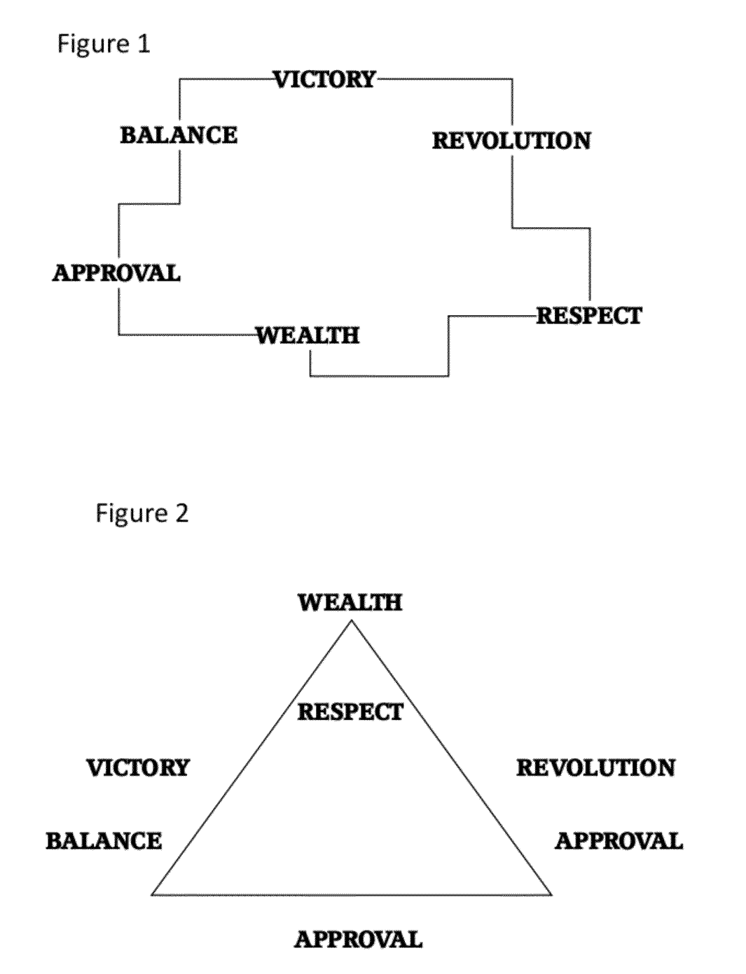

### (See FIG. 1)

Here is an example of how the system can be applied not only to individuals, but to an entity such as a business. Within a business structure, an understanding of these motivants can be applied to the process itself, or, to the individuals in the process. In that case, knowing the motivants, and thus, the strengths and weaknesses of the employees, would ensure that an employee is being put to best use given their talents and abilities, in order that the company and its projects run smoothly and successfully.

Projects tend to begin in the Victory mode. This is because Victory is formed with vision and feeling and thus tends to produce inspiring visions to be accomplished. It is successful in motivating others to action and therefore Victory makes for good leadership. Its strategy for accomplishment is to focus more towards short term achievement, and because it lacks long-term thought or rules (auditory), it tends to lead to bravery, at times to the level of foolhardy. Revolution mode is next. With its combination of Vision and Thought, it too can see where Victory wanted to go but expands it to add a more long-term strategic approach. This would be the brainstorming and phase, where possible innovations, architectural structures for future enhancements, and cautious contingency plans are explored. In addition, it seeks to align the goal with a core principle. By this point, the combinations of these two for a company's overall philosophy usually result in a vision statement, which is the combination of an objective that is rooted in a principle.

This vision statement usually contains the seeds that lead to the next mode, which is Respect. Respect is formed with Vision and Auditory. We've found auditory to be linked to rules, most likely due to the very syntax and linguistic properties of verbal communication that are essentially a series of rules. We found auditory also to be linked to hierarchy, self in relation to hierarchy, enforcement of rules given this hierarchy, and social charm and performance when given permission to take center stage. Revolution tends to stay in thought so it is important, just as Revolution helps Victory to consider long-term effects, for Respect to help Revolution put good ideas into practice by limiting what is and isn't to be implemented through a set of rules as determined by those in the upper ends of hierarchy. For better or worse, this may compromise some of the principles sought for during the Revolution phase but is a necessary step to progression. This is where company handbooks and corporate policy are put into place, full of rules and hierarchy. This is where project plans, schedules, decisions, and priorities are made to get the ball rolling.

Wealth mode follows. Because Wealth mode is formed with double vision, and we're found vision to be linked to action and impatience, this mode is primarily defined by committing to take action or use resources towards a desired objective. It is not held back from taking action by thoughts, emotions, or rules, even if rules were the springboard for action. This is the moment of faith where one does not think of what might happen, good or bad, does not focus on what they're feeling, and does not limit themselves by what was done before.

Approval mode is next. This is perhaps the biggest jump of all because Wealth and Approval tend to see things in an opposite fashion. Wealth desires preferential treatment and Approval seeks equality. This section of Approval, however, is essential to determine whether or not the results sought after have been accomplished and what modifications need to be considered. In this area, Approval's structure of Thinking and Feeling serves a project well: it can quickly adapt by sensing what is happening in the physical environment or in the minds of others, and then quickly think about what can be changed so that a positive feeling is accomplished. By responding in such a fashion, it allows for decision to be made; whether to loop back to a previous mode, i.e. go back to the drawing boards of Victory and Revolution, whether to change company policy, whether to be more or less considerate, or whether just to keep taking action.

Balance is the last mode. Its formation of Feeling and Auditory (rules) help to organize all of these results. With its lack of vision, it does not show an impatience for performing a postmortem on the process but rather will take the time to rearrange (feeling) these results and the process itself so that only the best rules are kept. This ensures stability for future results. Balance also enjoys relaxed festivities, i.e. nice ambience (feeling) and music (auditory), which can help provide reward and celebration so that morale and motivation are lifted and the entity is led to repeat the cycle.

The challenges that then arise from this cycle are evident once you analyze an entity's profile. If we use the example of the Revolution-Victory person, we can clearly see that the combination of Revolution and Victory would help this person start projects but not necessarily finish them. The Revolution aspect would be focused more on the ideal and the long term, the Victory on the short cuts and vision; would have a more difficult time creating rules of Respect that look to limit that person's actions. In addition, taking action without thoughts, feelings or rules, as with Wealth, would be contrary to their nature, giving them a tendency to skip to Approval mode; or, jump to Balance in a celebratory way without taking enough action. The difficult thing to see is not that they wouldn't take action, but that it would be toward initial vision and short term gains as well as brainstorming and long-term theory minus the needed limiting and paring down to create simple, prioritized rules, absent of thought, which can be acted upon quickly.

What is claimed is:

1) A system for identifying and analyzing an entity's motivations and associated characteristics, comprising of:
a) means for a classifying and measuring the substantial presence of sensory block indicators exhibited by said entity; and
b) means for determining predetermined patterns of sensory blocks combinations to show presence of motivations,
whereby an entity's predominate said motivations are revealed and vital information can be considered.

2) The system of claim 1 wherein said entity's motivations can be tracked moment-to-moment and across time to identify temporary modes, permanent profiles, and overlay effects.

3) The system of claim 1 wherein said entity's motivations can be consciously altered through the use of increasing or decreasing sensory block overlays to produce desired effect.

4) The system of claim 1 wherein said classifying and measuring presence of sensory block indicators is selected from the group consisting of Visual, Auditory, Feeling, and Thinking.

5) The system of claim 1 wherein said classifying and measuring presence of sensory block indicators is performed using eye patterns, head lean patterns, word cues, gestures, and facial expressions.

6) The system of claim 1 wherein said entity has the primary and secondary motivations which combined to form the goal motivations.

7) The system of claim 1 wherein understanding, communication, business transactions, and conscious shifts can be used for a positive intent in aspects of human interaction.

8) The system of claim 1 wherein the motivations are selected from the group consisting of Respect, Revolution, Wealth, Balance, Approval, Victory, and Artistic.

9) The system of claim 1 wherein the motivations are formed by the substantial presence of Visual and Auditory for Respect, Visual and Thinking for Revolution, Visual and Visual for Wealth, Feeling and Auditory for Balance, Feeling and Thinking for Approval, Feeling and Visual for Victory, and Thinking and Auditory for Artistic.

10) The system of claim 1 wherein motivations are anticipated to shift to equilibrium by forming the motivations of the sensory block indicators not substantially present in initial motivations. During this shift, initial sensory blocks are separated and manifest internally.

11) The system of claim 1 wherein automation of profiling can be achieved through the use of a computer program or apparatus thereafter.

12) A method for assessing and altering an entity's motivations and associated characteristics, comprising of:
a) means for a classifying and measuring the substantial presence of sensory block indicators exhibited by said entity; and
b) means for determining predetermined patterns of sensory blocks combinations to show presence of motivations,
whereby an entity's predominate motivations are revealed and vital information can be considered.

13) A method for identifying and analyzing an entity's motivations and associated characteristics, comprising of:
a) tracking a predominate and consecutive sequence of eye-accessing cue patterns;
b) assigning the motivations formed by the substantial presence of Visual and Auditory for Respect, Visual and Thinking for Revolution, Visual and Visual for Wealth, Feeling and Auditory for Balance, Feeling and Thinking for Approval, Feeling and Visual for Victory, and Thinking and Auditory for Artistic;
c) means for determining predetermined patterns of sensory blocks combinations to show presence of motivations; and
d) tracking moment-to-moment and across time to identify temporary modes, permanent profiles, and overlay effects.

14. The method of claim 12 wherein said entity's motivations can be consciously altered through the use of increasing or decreasing sensory block overlays to produce desired effect.

15. The method of claim 12 wherein said classifying and measuring presence of sensory block indicators is performed using eye patterns, head lean patterns, word cues, gestures, and facial expressions.

16. The method of claim 12 wherein said entity has primary and secondary motivations which combined to form goal motivations.

17. The method of claim 12 wherein understanding, communication, business transaction, and conscious shifts can be used for a positive intent in aspects of human interaction.

18. The method of claim 12 wherein automation of profiling can be achieved through the use of a computer program or apparatus thereafter.
